(19) United States
(12) Patent Application Publication
(10) Pub. No.: US 2020/0003115 A1
(43) Pub. Date: Jan. 2, 2020

(54) TURBOCHARGED GAS TURBINE ENGINE WITH ELECTRIC POWER GENERATION FOR SMALL AIRCRAFT ELECTRIC PROPULSION

(71) Applicant: Florida Turbine Technologies, Inc., Jupiter, FL (US)

(72) Inventors: Russell B. Jones, North Palm Beach, FL (US); Robert A. Ress, JR., Carmel, IN (US)

(21) Appl. No.: 16/484,645

(22) PCT Filed: Jan. 29, 2018
(86) PCT No.: PCT/US18/15716

§ 371 Date: Aug. 8, 2019

Related U.S. Application Data
(60) Provisional application No. 62/456,145, filed on Feb. 8, 2017.

(51) Int. Cl. F02C 3/073; F02C 7/18; F02C 3/10

(52) U.S. Cl. CPC F02C 3/073; F02C 3/10; F02C 7/18

(57) ABSTRACT

A turbocharged gas turbine engine with an electric generator to provide electrical power for an aircraft (e.g., UAV) with multiple propulsor fans each driven by an electric motor, where the engine includes a low spool that drives a main fan and a high spool that drives a high speed electric generator. The low pressure compressor supplies low pressure air to an inlet of the high pressure compressor. A row of stator vanes in the high pressure turbine is cooled using cooling air bled off from the low pressure compressor outlet that is passed through an intercooler and a boost compressor, where the spent vane cooling air is discharged into the combustor. The low pressure turbine and the two compressors each include a variable inlet guide vane to control the power level of the engine. Bypass flow from the main fan is used to cool hot parts of the engine.

### CROSS-REFERENCE TO RELATED APPLICATIONS

This application claims the benefit to U.S. Provisional Application No. 62/456,145, filed on Feb. 8, 2017, entitled TURBOCHARGED GAS TURBINE ENGINE WITH ELECTRIC POWER GENERATION FOR SMALL AIRCRAFT ELECTRIC PROPULSION, the entirety of which is incorporated herein by reference.

### GOVERNMENT LICENSE RIGHTS

None.

### TECHNICAL FIELD

The present invention relates generally to a small gas turbine engine with electric power generation, and more specifically to a UAV with a gas turbine engine driven electric generator for propulsion.

### BACKGROUND

Electric power generation onboard aircraft is desired to enable optimization of electric driven propulsion devices (propulsor fans) to power the aircraft in flight. FIG. 6 shows a two-shaft turbo fan engine of the prior art with nested shaft arrangements with a low speed shaft and a low speed fan 38, connected to a low speed low pressure compressor 34 driven by a shaft connected to a low pressure turbine 35. The high pressure compressor 31 is connected with a hollow shaft to the high pressure turbine 33. The high pressure turbine 33 shaft is positioned through the center of a combustor 32. The low pressure turbine 35 shaft is routed through the center of the high speed shaft. In this arrangement, the largest percentage of the power generated by the gas turbine engine is delivered to the low speed fan 38 creating thrust to propel the aircraft. The exhaust from the core flow (flow that passed through the combustor 32), is routed out of the turbine and passed through an exhaust nozzle 39, creating additional thrust from both the engine core and the low speed fan 38. The combination of fan thrust and core exhaust thrust sum to the power rating of the engine.

Prior art stationary gas turbines are shown in FIGS. 1, 2, and 3. FIG. 1 shows the single-shaft gas turbine generator configuration with the generator 15 directly coupled to the turbine shaft. This engine includes a compressor 11, a combustor 12, a turbine 13, and an exhaust diffuser 14. Typical power generation gas turbines used in stationary gas turbine applications are single-shaft engines whereby the generator 15 is electrically connected to a synchronized power grid. In most cases the power grid runs at 60 hertz and naturally wants a commercially available generator at either 1,800 or 3,600 rpm. In other areas, 50 hertz is required where the generator shaft speed is desired at 1,500 or 3,000 rpm. These stationary gas turbine power generation units are designed with either single shaft direct drive arrangement for large utility applications where the turbine is optimized for the aforementioned shaft speeds, or a gearbox is implemented where the turbine output speed is reduced to necessary speed of the generator application.

FIG. 2 shows a second prior art gas turbine generator configuration where the engine is a two-shaft variant. In this configuration the generator 15 is attached to the low pressure turbine 17 spool that is connected to the low pressure compressor 16 driven by the low pressure turbine 17. Additionally, the compressor 11 is a high pressure compressor 11 and the turbine 13 is a high pressure turbine 13. The shaft of the low pressure compressor 16 passes through the high pressure rotor (high pressure compressor 11 and high pressure turbine 13 with a combustor 12 in-between) that rotates at a much higher speed. An exhaust diffuser 14 is located downstream from the low pressure turbine 17. This arrangement is often seen as an aero-derivative configuration, as an aircraft turbo-fan seen in FIG. 6 prior art is easily modified to a power generator by removing the fan and connecting a generator 15 to the LP compressor shaft. Additionally, modifications are made by removing the exhaust thrust nozzle and replacing it with a turbine exhaust diffuser 14. The turbine exhaust diffuser 14 allows for a higher expansion ratio to be taken over the turbine and maximizing the turbine power. In this configuration the generator 15 is coupled to the low speed shaft whereby the generator 15 is much larger and heavier than a high speed generator of the same power size.

FIG. 3 depicts another prior art turbine generator arrangement where the two-spool aero-derivative turbo fan engine (shown in FIG. 6) is adapted for use as a power generator by removing the fan duct and fan stage and adding a free power turbine 21 that is used to drive the electric generator 15. This engine includes a low spool with a low pressure compressor 16 connected to a low pressure turbine 17 with a combustor 12 in-between, and a high pressure compressor 11 connected to a high pressure turbine 13 in the high spool. Exhaust from the two turbines 13 and 17 passes through the power turbine 21 to drive the electric generator 15. An exhaust diffuser 22 is located downstream from the power turbine 21. In this configuration the power turbine 21 is the slowest rotational speed and thus has a very large and heavy generator 15 as compared to higher speed generators for the same power capacity.

FIG. 4 shows prior art configuration of a turbo jet engine wherein all of the engine thrust is developed by the exhausting core turbine flow exiting the thrust nozzle. This engine includes a compressor 23 connected to a turbine 25 with a combustor 24 in-between, and an exhaust nozzle 26 downstream from the turbine 25.

FIG. 5 shows prior art of a typical turbo prop engine configuration with the propeller 36 driven by the low pressure compressor 34 shaft (often through a reduction gearbox). The high pressure compressor 31 and high pressure turbine 33 are used to increase the pressure ratio of the turbine and increase the low pressure turbine power and overall engine efficiency. This engine includes a combustor 32 in-between the high pressure compressor 31 and high pressure turbine 33 and an exhaust duct 37 downstream from the low pressure turbine 35. This embodiment is easily modified into a turbo generator configuration by removing the propeller and replacing it with the generator of the same power rating than that of the propeller power consumption. In this generation derivative, the generator 15 would be spinning at low speed and thus be heavy as compared to a higher speed generator of the same power rating.

FIG. 6 shows a turbofan aero engine of the prior art that includes a low pressure compressor 34 driven by a low pressure turbine 35 with a combustor 32, a high pressure compressor 31 driven by a high pressure turbine 33, a fan 38 driven by the low spool (34 and 35), and an exhaust nozzle 39 located downstream from the low pressure turbine 35. The fan thrust and the core thrust are indicated by the arrows downstream of the exhaust nozzle 39.

### SUMMARY

A turbocharged two shaft gas turbine engine that drives an electric generator for electric power production that is used to drive multiple electric fans for a small aircraft such as a UAV. Over-pressurized cooling air is produced using an external compressor driven by an external electric motor where the over-pressurized cooling air is used to cool hot parts of the high pressure turbine such as rotor blades and stator vanes, where the spent over-pressurized cooling air from the hot parts is then redirected through the engine and discharged into the combustor with enough pressure to be burned with fuel. The over-pressurized cooling air is bled off from a low pressure compressor and then passed through an inter-cooler to decrease its temperature prior to being used to cool turbine hot parts. A high speed direct drive electric generator is rotatably connected to the high spool (high speed shaft) of the engine instead of the low spool (low speed shaft) so that a lightweight generator can be used and thus saving space and weight for use as an aircraft power plant.

In a first embodiment of the turbocharged aero gas turbine engine, a fan, a low pressure compressor, a low pressure turbine, and a high pressure turbine are all located forward of a combustor, and a high pressure compressor, a direct drive high speed electric generator, and an exhaust nozzle are all located aftward of the combustor. The generator is driven by the high spool.

In a second embodiment of the turbocharged aero gas turbine engine, a high pressure compressor and an electric generator are all located forward of a combustor, and a high pressure turbine, a low pressure turbine, a low pressure compressor, a fan, and an exhaust nozzle are all located aftward of the combustor. The generator is driven by the high spool. Air flow from the fan flows forward and then turned 180 degrees to flow aftward for propelling the aircraft.

In a third embodiment of the turbocharged aero gas turbine engine, a high pressure compressor, an electric generator, a low pressure compressor, and a fan are all located forward of a combustor, and a high pressure turbine, a low pressure turbine, and an exhaust nozzle are all located aftward of the combustor. The generator is driven by the high spool. A low spool rotates within a high spool with the high spool connected to the electric generator.

In each of the three embodiments of the present invention, a cooling system is used to provide cooling to a hot part of the turbine such as the first row of stator vanes, and where the spent cooling air is discharged into the combustor instead of the turbine. To overcome pressure loss from passing through the row of stator vanes, a boost compressor is used to increase the cooling air pressure so that the spent cooling air from the stator vanes can flow into the combustor. Cooling air for the stator vanes can be bled off from the low pressure compressor at the last stage or an earlier stage in the compressor, and then passed through an intercooler to be cooled, and then passed through a boost compressor to increase the pressure of the cooling air such that the cooling air can flow through the stator vanes and then flow into the combustor.

An intercooler is used to provide cooling for the cooling air from the low pressure compressor prior to passing through the stator vanes. External aircraft air can be used as the other fluid passing through the intercooler to provide cooling of the compressed air that is used to cool the turbine stator vanes. The cooling air for the turbine stator vanes must be at a higher pressure than the low pressure compressor discharge pressure (referred to as P3) if the spent cooling air is to be discharged into the combustor. The cooling air for the stator vanes is pressurized in stages with the low pressure compressor first and then the boost compressor second in order to use less work on compressing the cooling air.

In each of three embodiments of the present application, bypass flow from the main fan is used to cool hot parts of the engine such as the turbines and the combustor. Electricity produced by the generator is used to power additional fans that propel and steer the aircraft.

Another source of coolant for the intercooler could be fuel from the aircraft tank. Fuel could be circulated from the tank and through the intercooler to cool the compressed air, and then the fuel discharged back into the tank. This could also be a way for heating up the fuel within the tank when the aircraft is operating at high altitude. In another embodiment, the heated fuel could be discharged into the combustor and burned with other fuel to produce the hot gas flow.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a single shaft gas turbine engine with electric power generation of the prior art;

FIG. 2 shows a two shaft gas turbine engine with electric power generation of the prior art;

FIG. 3 shows another two shaft gas turbine engine with electric power generation of the prior art;

FIG. 4 shows a single shaft turboprop gas turbine engine of the prior art;

FIG. 5 shows a two shaft turboprop gas turbine engine of the prior art;

FIG. 6 shows a two shaft turbofan gas turbine engine of the prior art;

FIG. 7 shows a turbocharged gas turbine engine for electric power production in a first embodiment of the present invention;

FIG. 8 shows a turbocharged gas turbine engine for electric power production in a second embodiment of the present invention;

FIG. 9 shows a turbocharged gas turbine engine for electric power production in a third embodiment of the present invention; and

FIG. 10 shows an exemplary aircraft propelled by a plurality of propulsor fans.

### DETAILED DESCRIPTION

The present disclosure describes arrangements of two-shaft gas turbine engines that have a high speed generator directly and rotatably connected to the high speed turbine shaft. The arrangement, among other features that enable high turbine efficiency, allows for a compact engine arrangement having robust rotor dynamic behavior, and with light weight architecture. Having the generator on the high speed shaft enables the lightest generator as compared to those on the low speed shafts or a de-coupled free power turbine shaft. This allows for a lightweight and smaller volume power plant for a small aircraft such as an Unmanned Aero Vehicle or UAV, which then allows for the UAV to carry more fuel and thus allows for more hover time over a target.

The cycle is further optimized with cooling air bled from the low pressure compressor that is intercooled, and further compressed to a pressure greater that the high pressure compressor discharge pressure. The over-pressurized compressed intercooled air is utilized for turbine section cooling such as rotor blades, stator vanes, blade outer air seals, and internal cooling. The air post-cooling is exhausted from the components having been cooled, and is collected and routed and injected upstream of the combustor. This flow used for cooling would ordinarily be discharged to the turbine hot gas path where the temperature of the discharge dilutes the overall gas stream temperate reducing power and efficiency of the engine cycle. The engines have a combination of electrical generation combined with additional fan bypass duct thrust and core engine exhaust flow thrust to optimize the engine cycle and to provide for tailored cooling forced convection airflow to cool the generator and the turbine combustor and turbine casings. The discharge of the very low bypass fan duct creates a small amount of thrust that will augment the propulsion of the aircraft in addition to the electrically driven propulsor fans with electrical power produced from the generator. The electric generator 48 produces electrical power that is used to drive a number of propulsor fans that also propel and steer the aircraft during flight.

Challenges in the architecture of integrating a high speed generator onboard an aircraft are many and include reducing the weight of the generator, managing the air inlet flow stream, managing the exhaust gas stream, and keeping the overall cycle at a high efficiency operating point for fuel efficiency.

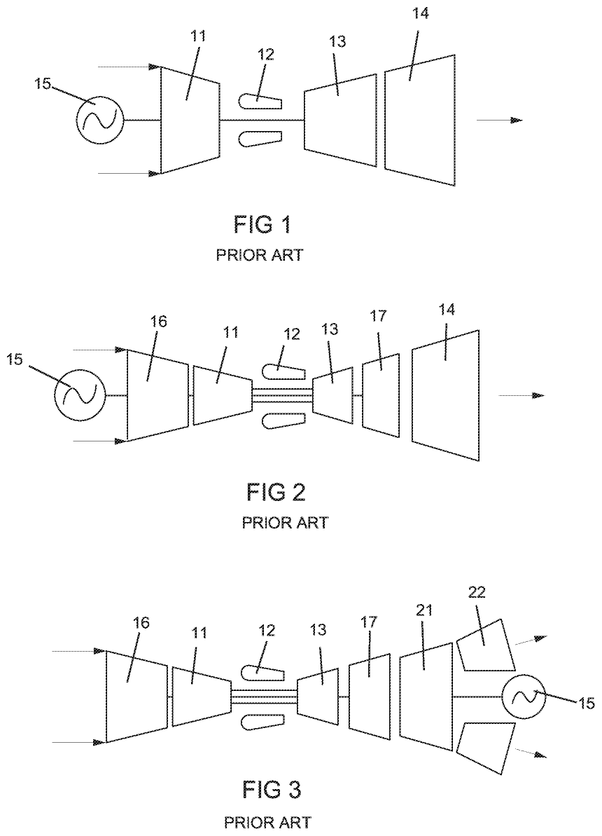

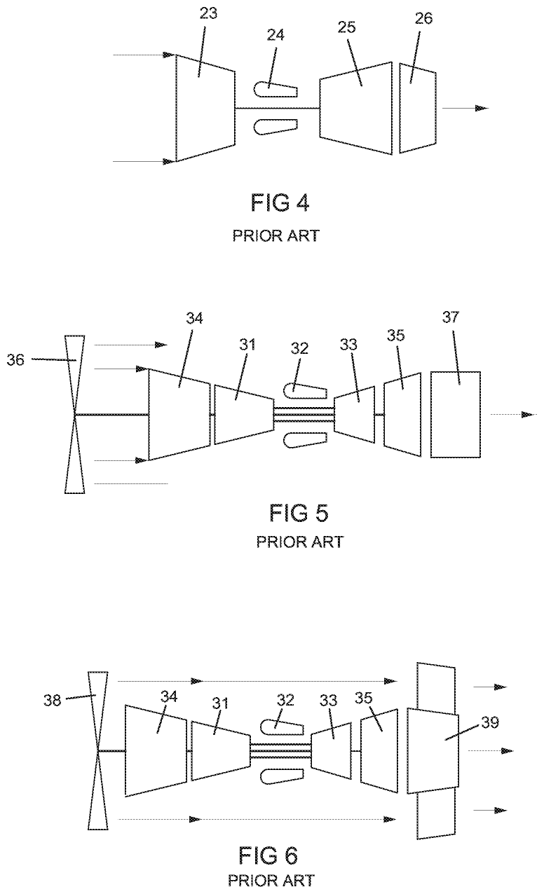

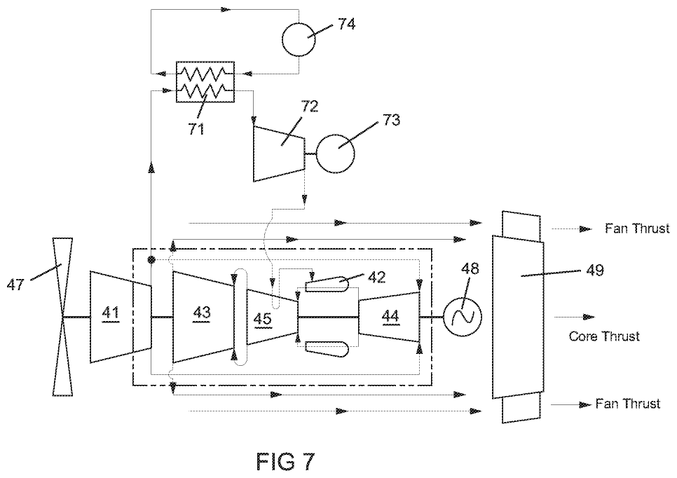

FIG. 7 shows the present invention of an aircraft power generation unit whereby the electric generator 48 is attached to the highest speed shaft of the gas turbine engine. FIG. 7 shows a schematic indication of the engine in the first embodiment. This engine includes a low pressure compressor 41 driven by a low pressure turbine 43, a high pressure compressor 44 driven by a high pressure turbine 45, a combustor 42 in-between the high pressure turbine 45 and the high pressure compressor 44, a main fan 47 driven by the low spool, and a direct drive high speed electric generator 48 driven by the high spool. In the FIG. 7 embodiment, the airflow enters the main fan 47 stage shown on the left side of the figure. The main fan 47 has a very low bypass ratio (mass flow through the bypass duct divided by the mass flow of the core engine flow). The flow leaving the main fan 47 stage splits into two streams. The first stream is the main fan bypass flow. The bypass ratio is seen to be 1 or smaller as the flow is utilized for forced cooling through an intercooler 71 for enhanced cooling air performance, and additionally providing cooling air to the turbine casings. The exhausting fan duct flow passes through a thrust or exhaust nozzle 49 that provides an additional component of thrust that helps power the vehicle's flight. It is desired to have the airflow pass thorough the exhaust nozzle 49 as the structure of the exhaust nozzle 49 is compact and light weight as compared to that of the IGT arrangements in FIGS. 1, 2 and 3, which have exhaust diffusers that minimize the thrust but add significant structure and engine weight.

Cooling air for hot parts in the turbine is bled off from the low pressure compressor 41, passed through an intercooler 71, further compressed by an external compressor 72 (a boost compressor 72) driven by an electric motor 73, and passed through a hot part of the high pressure turbine 45 such as within internal cooling air passages within a first row of stator vanes for cooling. The spent cooling air is then collected and discharged into the combustor 42 of the engine. The external compressor 72 increases a pressure of the cooling air such that the cooling air can pass through the cooled turbine hot parts and have enough pressure to be discharged into the combustor 42 at around the same pressure as the discharge pressure from the high pressure compressor 44. A second fluid is passed through the intercooler 71 and pressurized by a pump 74 to provide cooling of the compressed air from the low pressure compressor 41 to the external compressor 72. This secondary coolant passing through the intercooler 71 can be external air from the aircraft or fuel from the aircraft fuel tank. Outside air can be used to pass through the intercooler 71 and then discharged out from the aircraft in an open loop path. Or, fuel could be recirculated between the intercooler 71 and the fuel tank so that the fuel in the tank can be heated in a closed loop path. Or, the fuel could be discharged into the combustor 42 to be burned with other fuel in an open loop path.

The second stream of the main fan discharge is routed into the low pressure compressor 41 that is directly and rotatable connected to the low pressure turbine 43. The flow discharging the low pressure compressor 41 is extracted and ducted to the right side of the figure and enters the high pressure compressor 44. The ducting could be a continuous duct or bifurcated into two or more passages to deliver the flow to the high pressure compressor 44. The flow leaving the high pressure compressor 44 enters the combustor 42 where fuel is added and combusted at high pressure driving the high pressure turbine 45. The high pressure turbine 45 is directly and rotatably connected to the high pressure compressor 44 with a shaft extending and connecting to the direct drive high speed electric generator 48. The flow exiting the high pressure turbine 45 enters the low pressure turbine 43 that powers the low pressure compressor 41 and the main fan 47. The core flow exiting the low pressure turbine 43 is ducted to the rear of the engine and is passed through the exhaust nozzle 49 providing the aircraft with some additional thrust.

The engine utilizes a cooling air extraction for the exit of the low pressure compressor 41 where the flow is delivered to an intercooler 71 (cooled by the fan bypass air, or external aircraft air, or by conduction to the aircraft skin). The cooled low pressure extraction air is then further compressed (by an external compressor 72 driven by an external electric motor 73) to a level above that of the high pressure compressor 44 exit. This cooling air after “over pressurization” is discharged at a temperature to cool turbine components in a closed loop cooling that returns the coolant (the over-pressurized spent cooling air) to the upstream of the combustor 42 allowing the flow to pass through the combustor 42.

In most prior art cooling configurations, the coolant delivered to the turbine components for internal cooling is at a pressure such that the flow passes through the component and is discharged to a lower pressure location in the turbine flow path. This would typically be at the trailing edge or a locally high velocity region on the airfoil surface where the static pressure is lower than the coolant discharge pressure. This intercooling and over-pressurization of the cooling air extraction of the present invention increases the turbine thermal efficiency and thus the power output of the power generation.

The invention having the electric generator 48 on the high speed turbine shaft minimizes the generator weight which is important for an aircraft power plant. The intercooled boost compression cooling air with return to the combustor 42 shell optimizes the thermal efficiency and turbine power. The main fan bypass flow is also used to cool hot parts of the engine such as the combustor 42 and the high pressure turbine 45 and even the electric generator 48 by flowing over these parts. The main fan bypass ratio of very low level provides for the necessary intercooling and/or turbine case cooling flows necessary to manage turbine tip clearances, and the thrust nozzle that take the exhausting fan and core exhaust and convert to thrust accelerating through the exhaust nozzle resulting in additional aircraft thrust. The resulting engine has very high power to weight ratio which is ideal for use as an aircraft power plant.

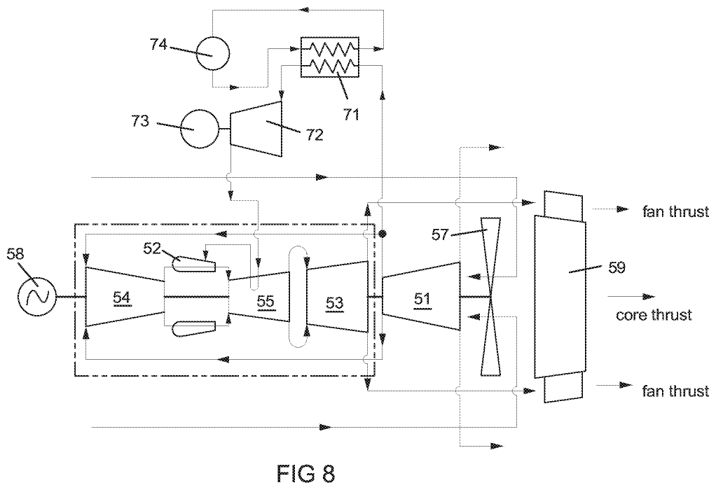

FIG. 8 is an arrangement similar to FIG. 7 where the electric generator 58 is coupled to the high speed shaft. This engine includes a low pressure compressor 51 driven by a low pressure turbine 53, a high pressure compressor 54 driven by a high pressure turbine 55, a combustor 52 located between the high pressure compressor 54 and the high pressure turbine 55, a main fan 57 driven by the low spool, and an electric generator 58 driven by the high spool. In this arrangement, the electric generator 58 is positioned to the forward facing side of the aircraft. Having the electric generator 58 in this position provides beneficial weight distribution of the engine if mounted on a wing structure. The center of gravity of the composite turbine generator is expected to be near the left hand end of the high pressure compressor 54.

In the FIG. 8 embodiment, the airflow is passed over the electric generator 58 that keeps the stator of the electric generator 58 cooled to acceptable levels. The air is routed to the aft of the engine where it is reversed in direction and enters the main fan 57 stage. The flow is split into two streams as described in the FIG. 7 description. The fan flow and core flow both pass into an exhaust nozzle 59 where additional thrust is developed helping to propel the aircraft. In the FIG. 8 embodiment, the main fan 57 is cut short so that no bypass flow is created. The main fan 57 thus functions as a first stage blade in which all of the air flow from the fan flows into an inlet of the low pressure compressor 51. This is different than in the FIG. 7 embodiment where the main fan is not cut short so that a small amount of bypass flow is created that flows around the low pressure compressor 51. The FIG. 8 embodiment shows outside air flowing toward the main fan 57 then turning to flow into the main fan 57 where some of the main fan outlet turns 180 degrees as bypass flow around the LP compressor 51. The main fan 57 in the FIG. 8 embodiment is a forward flowing fan. This flow can be eliminated from the design such that no bypass flow in created by the fan 57.

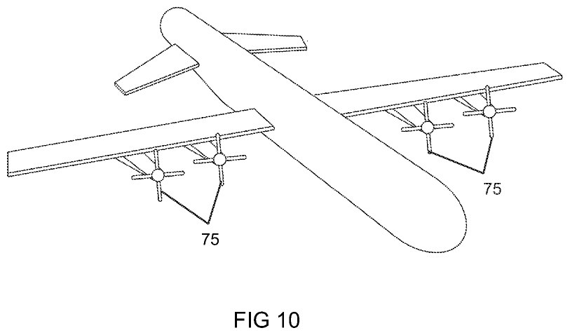

An intercooler 71 is used to provide cooling of the compressed cooling air used for the stator vanes. The secondary coolant passing through the intercooler 71 can be outside air external of the aircraft or the fuel from the aircraft fuel tank. The intercooler 71 works the same way as in the FIG. 7 embodiment. The electric generator 58 produces electrical power that is used to drive a number of propulsor fans for additional propulsion and for steering of the aircraft. An exemplary aircraft having a plurality of propulsor fans 75 is shown in FIG. 10.

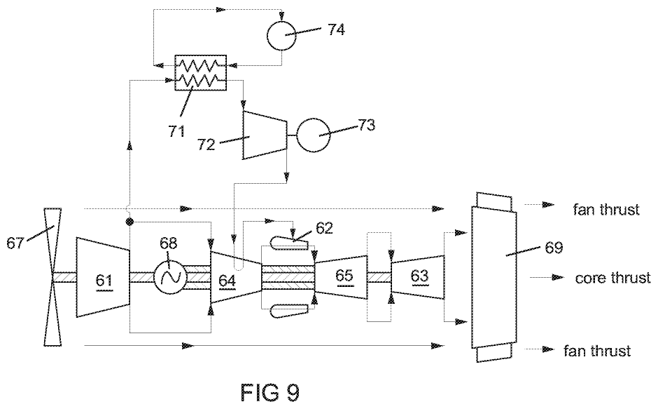

FIG. 9 shows another embodiment of the small aircraft power plant where the electric generator 68 is attached to the high speed compressor shaft that rotates independent of the low pressure shaft connecting the main fan 67, low pressure compressor 61, and low pressure turbine 63. This engine includes a low pressure compressor 61 driven by a low pressure turbine 63, a high pressure compressor 64 driven by a high pressure turbine 65, a combustor 62 located between the high pressure compressor 64 and the high pressure turbine 65, a main fan 67 driven by the low spool, an electric generator 68 driven by the high spool, and an exhaust nozzle 69. The low spool passes through the high spool, where the high spool drives the electric generator 68. The flow routing is more straightforward where the main fan duct passes around the core engine. The core engine flow passes through the low pressure compressor 61, is ducted around the electric generator 68, and enters the high pressure compressor 64. The high pressure compressor 64 discharge enters the combustor 62 where fuel is added and is then expanded through the high pressure turbine 65, low pressure turbine 63, and then with the main fan duct exhaust through the exhaust nozzle 69. Additionally, compressed cooling air from the intercooler 71 and external compressor 72 may be passed through a hot part of the high pressure compressor 64 of the engine (for example, as shown in FIG. 9), such as within internal cooling air passages in a first row of stator vanes. However, it will be understood that the compressed cooling air may additionally or alternatively be passed through another hot part, such as within internal cooling air passages in a first row of stator vanes in the high pressure turbine 65. The electric generator 58 produces electrical power that is used to drive a number of propulsor fans for additional propulsion and for steering of the aircraft.

It is expected that these configuration can deliver over 90% of the power to the electric generator 68 and develop less than 10% thrust relative to the generated electrical power.

In each of the three embodiments of the present inventions above, variable geometry guide vanes are used in the low pressure compressor, high pressure compressor, low pressure turbine, low pressure bleeds, and variable flow capacity low pressure turbine guide vane would be used to control the two shaft speeds along with the fuel scheduling.

In each of the three embodiments of the present inventions above, an intercooler with a boost compressor is used to take compressed air from the low pressure compressor and pass the cooling air through parts of the turbine such as the first row of stator vanes for cooling, and then discharge the spent stator vane cooling air into the combustor. The intercooler cools the cooling air prior to entry into the boost compressor to improve the efficiency of the boost compressor. Outside air from the aircraft can be passed through the intercooler as the coolant for cooling of the cooling air to the stator vane row.

In one embodiment, a power plant for an aircraft propelled by a plurality of propulsor fans comprises: a low spool having a low pressure compressor (41, 51, 61) driven by a low pressure turbine (43, 53, 63); a high spool having a high pressure compressor (44, 54, 64) driven by a high pressure turbine (45, 55, 65); a combustor (42, 52, 62) positioned between the high pressure compressor (44, 54, 64) and the high pressure turbine (45, 55, 65); an outlet of the low pressure compressor (41, 51, 61) is connected to an inlet of the high pressure compressor (44, 54, 64); the low pressure turbine (43, 53, 63) includes a variable inlet guide vane; the low pressure turbine (43, 53, 63) is located adjacent to the high pressure turbine (45, 55, 65) and hot exhaust from the high pressure turbine (45, 55, 65) flows into the low pressure turbine (43, 53, 63); a main fan (47, 57, 67) driven by the low spool; an electric generator (48, 58, 68) driven by the high spool; an exhaust nozzle (49, 59, 69) to receive hot exhaust from the low pressure turbine (43, 53, 63); the high pressure turbine (45, 55, 65) having a row of stator vanes with internal cooling air passages; and an intercooler (71) with a boost compressor (72) connected to the low pressure compressor (41, 51, 61) and the combustor (42, 52, 62) through the internal cooling air passages of the row of stator vanes.

In one aspect of the embodiment, the main fan (47, 67) is located forward of the low spool, the high spool is located aft of the low spool, and the electric generator (48, 68) is located between the high spool and the exhaust nozzle (49, 69).

In one aspect of the embodiment, the hot gas exhausted from the low pressure turbine (53) is turned 180 degrees to flow through the exhaust nozzle (59).

In one aspect of the embodiment, the electric generator (58) is located forward of the high spool, the low spool is located aft of the high spool, the main fan (57) is located aft of the low spool, and the main fan (57) is a forward flowing fan.

In one aspect of the embodiment, the main fan (67) is located forward of the low pressure compressor (61), the electric generator (68) is located aft of the low pressure compressor (61), the high pressure compressor (64) is located aft of the electric generator (68), the high pressure turbine (65) is located aft of the high pressure compressor (64), the low pressure turbine (63) is located aft of the high pressure turbine (65), and the low spool passes through the electric generator (68).

In one aspect of the embodiment, the low pressure compressor (61) and the high pressure compressor (64) both include a variable inlet guide vanes.

In one aspect of the embodiment, the electric generator is configured to supply electrical power to the plurality of propulsor fans.

In one aspect of the embodiment, the main fan produces a bypass flow that is used to cool hot parts of the engine.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A power plant for an aircraft propelled by at least one propulsor fan, the power plant comprising:
a low spool having a low pressure compressor driven by a low pressure turbine;
a high spool having a high pressure compressor driven by a high pressure turbine;
a combustor positioned between the high pressure compressor and the high pressure turbine;
an outlet of the low pressure compressor is connected to an inlet of the high pressure compressor;
the low pressure turbine includes a variable inlet guide vane;
the low pressure turbine is located adjacent to the high pressure turbine and hot exhaust from the high pressure turbine flows into the low pressure turbine;
a main fan driven by the low spool;
an electric generator driven by the high spool;
an exhaust nozzle to receive hot exhaust from the low pressure turbine;
the high pressure turbine having turbine hot parts with internal cooling air passages; and
an intercooler with a boost compressor connected to the low pressure compressor and the combustor through the internal cooling air passages of the turbine hot parts.

2. The power plant for an aircraft propelled by at least one propulsor fan of claim 1, wherein:
the main fan is located forward of the low spool;
the high spool is located aft of the low spool; and
the electric generator is located between the high spool and the exhaust nozzle.

3. The power plant for an aircraft propelled by at least one propulsor fan of claim 1, wherein the hot gas exhausted from the low pressure turbine is turned 180 degrees to flow through the exhaust nozzle.

4. The power plant for an aircraft propelled by at least one propulsor fan of claim 1, wherein:
the electric generator is located forward of the high spool;
the low spool is located aft of the high spool;
the main fan is located aft of the low spool; and
the main fan is a forward flowing fan.

5. The power plant for an aircraft propelled by at least one propulsor fan of claim 1, wherein:
the main fan is located forward of the low pressure compressor;
the electric generator is located aft of the low pressure compressor;
the high pressure compressor is located aft of the electric generator;
the high pressure turbine is located aft of the high pressure compressor;
the low pressure turbine is located aft of the high pressure turbine; and
the low spool passes through the electric generator.

6. The power plant for an aircraft propelled by at least one propulsor fan of claim 1, wherein the low pressure compressor and the high pressure compressor both include a variable inlet guide vanes.

7. The power plant for an aircraft propelled by at least one propulsor fan of claim 1, wherein the electric generator is configured to supply electrical power to the plurality of propulsor fans.

8. The power plant for an aircraft propelled by at least one propulsor fan of claim 1, wherein the main fan produces a bypass flow that is used to cool hot parts of the engine.
